(19) United States
(12) Patent Application Publication
(10) Pub. No.: US 2022/0093322 A1
(43) Pub. Date: Mar. 24, 2022

(54) TRANSFORMER DEVICE OF BALANCED IMPEDANCE MATCHING

(71) Applicant: TAI-TECH ADVANCED ELECTRONICS CO., LTD., Taoyuan City (TW)

(72) Inventors: Hsiang Chung Yang, Taoyuan City (TW); Pao Lin Shen, Taoyuan City (TW); Ming Yen Hsieh, Taoyuan City (TW)

(21) Appl. No.: 17/031,761

(22) Filed: Sep. 24, 2020

(51) Int. Cl. H01F 27/29; H01F 27/24

(52) U.S. Cl. CPC H01F 27/29; H01F 27/24

(57) ABSTRACT

The transformer device includes a magnetic core having a coil section with a first flange and a second flange at two ends of the coil section. The first and second flanges respectively have a number of inner and outer electrodes. The electrodes are of equal dimensions. The outer electrodes are positioned relatively closer to the coil section than the inner electrodes. A number of windings are wound either clockwise or counterclockwise around the coil section. Each winding has its first end connected to an electrode on the first flange, and its second end connected an electrode on the second flange. Two center taps are provided, each having an end connected to an electrode on the first flange and another end connected to an electrode on the second flange. Through the above arrangement, signal paths along the windings are almost identical, thereby enhancing the balance of impedance matching.

### BACKGROUND OF THE INVENTION

### (a) Technical Field of the Invention

The present invention is generally related to transformers, and more particular to a transformer device of balanced impedance matching.

### (b) Description of the Prior Art

A conventional transformer device taught by People's Republic of China Patent No. CN201910613707, as shown in its FIGS. 1 and 7, has windings connected to electrodes.

As shown in its FIG. 7, a configuration is to provide the third electrode and fourth electrode for a second center tap and to provide the seventh electrode and eighth electrode for a first center tap. However, when signals are transmitted through the first electrode, second electrode, fifth electrode, and sixth electrode, the signals traverse paths of different lengths, causing unbalanced impedance matching and asynchronous signal transmission. Another configuration is to provide the first electrode and second electrode for a fourth center tap, and to provide the fifth electrode and sixth electrode for a third center tap. This configuration would suffer the same issue.

### SUMMARY OF THE INVENTION

Therefore, the objective of the present invention is to teach a transformer device enhancing the balance of impedance matching.

To achieve the objective, the transformer device includes

a magnetic core having a coil section;

a first flange at a first end of the coil section having outer electrodes including a first electrode and a fourth electrode and inner electrodes including a second electrode and a third electrode, where the inner electrodes are positioned between the outer electrodes, and the outer electrodes are positioned at a distance relative to an outer side of the first flange and therefore closer to the coil section than the inner electrodes;

a second flange at a second end of the coil section opposite to the first end having outer electrodes including a fifth electrode and an eighth electrode and inner electrodes including a sixth electrode and a seventh electrode, where the inner electrodes are positioned between the outer electrodes, and the outer electrodes are positioned at a distance relative to an outer side of the second flange and therefore closer to the coil section than the inner electrodes;

a number of windings around the coil section arranged into a first layer of winding and a second layer of winding, where each winding has a first end and a second end, the first end is connected to an electrode on the first flange, and the second end is connected an electrode on the second flange; and

two center taps, each having an end connected to an electrode on the first flange and another end connected to an electrode on the second flange;

wherein the outer electrodes on the first flange have equal length and width to those of the inner electrodes on the first flange; and the outer electrodes on the second flange have equal length and width to those of the inner electrodes on the second flange.

In a first embodiment, the first layer of windings includes a first winding and a second winding; the first and second windings are wound clockwise around the coil section, have their first ends respectively connected to the first and third electrodes, and have their second ends respectively connected to the seventh and fifth electrodes; the second layer of windings includes a third winding and a fourth winding; and the third and fourth windings are wound clockwise around the coil section, have their first ends respectively connected to the second and fourth electrodes, and have their second ends respectively connected to the eighth and sixth electrodes. A center tap is connected to the second and seventh electrodes; and another center is connected to the third and sixth electrodes. Alternatively, a center tap is connected to the first and eighth electrodes; and another center tap is connected to the fourth and fifth electrodes. Alternatively, a center tap is connected to the second and seventh electrodes; and another center tap is connected to the fourth and fifth electrodes. Alternatively, a center tap is connected to the first and eighth electrodes; and another center tap is connected to the third and sixth electrodes.

In a second embodiment, the first layer of windings includes a first winding and a second winding; the first and second windings are wound counterclockwise around the coil section, have their first ends respectively connected to the first and third electrodes, and have their second ends respectively connected to the seventh and fifth electrodes; the second layer of windings includes a third winding and a fourth winding; and the third and fourth windings are wound counterclockwise around the coil section, have their first ends respectively connected to the second and fourth electrodes, and have their second ends respectively connected to the eighth and sixth electrodes. A center tap is connected to the second and seventh electrodes; and another center is connected to the third and sixth electrodes. Alternatively, a center tap is connected to the first and eighth electrodes; and another center tap is connected to the fourth and fifth electrodes. Alternatively, a center tap is connected to the second and seventh electrodes; and another center tap is connected to the fourth and fifth electrodes. Alternatively, a center tap is connected to the first and eighth electrodes; and another center tap is connected to the third and sixth electrodes.

In a third embodiment, the first layer of windings includes a first winding and a second winding; the first and second windings are wound clockwise around the coil section, have their first ends respectively connected to the first and second electrodes, and have their second ends respectively connected to the seventh and eighth electrodes; the second layer of windings includes a third winding and a fourth winding; and the third and fourth windings are wound counterclockwise around the coil section, have their first ends respectively connected to the third and fourth electrodes, and have their second ends respectively connected to the fifth and sixth electrodes. A center tap is connected to the second and seventh electrodes; and another center is connected to the third and sixth electrodes. Alternatively, a center tap is connected to the first and eighth electrodes; and another center tap is connected to the fourth and fifth electrodes. Alternatively, a center tap is connected to the second and seventh electrodes; and another center tap is connected to the fourth and fifth electrodes. Alternatively, a center tap is connected to the first and eighth electrodes; and another center tap is connected to the third and sixth electrodes.

In a fourth embodiment, the first layer of windings includes a first winding and a second winding; the first and second windings are wound counterclockwise around the coil section, have their first ends respectively connected to the first and second electrodes, and have their second ends respectively connected to the seventh and eighth electrodes; the second layer of windings includes a third winding and a fourth winding; and the third and fourth windings are wound clockwise around the coil section, have their first ends respectively connected to the third and fourth electrodes, and have their second ends respectively connected to the fifth and sixth electrodes. A center tap is connected to the second and seventh electrodes; and another center is connected to the third and sixth electrodes. Alternatively, a center tap is connected to the first and eighth electrodes; and another center tap is connected to the fourth and fifth electrodes. Alternatively, a center tap is connected to the second and seventh electrodes; and another center tap is connected to the fourth and fifth electrodes. Alternatively, a center tap is connected to the first and eighth electrodes; and another center tap is connected to the third and sixth electrodes.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing a magnetic core of a transformer device according to the present invention.

FIG. 2 is a top-view diagram showing the magnetic core of FIG. 1.

FIG. 3 is a top view diagram showing a first layer of windings of a transformer device according to a first embodiment of the present invention.

FIG. 4 is a top view diagram showing a second layer of windings of a transformer device according to a first embodiment of the present invention.

FIG. 5 is a schematic diagram showing a first kind of connections of windings and center taps for the transformer device of FIGS. 3 and 4.

FIG. 5A is an equivalent circuit diagram of FIG. 5.

FIG. 6 is a schematic diagram showing a second kind of connections of windings and center taps for the transformer device of FIGS. 3 and 4.

FIG. 6A is an equivalent circuit diagram of FIG. 6.

FIG. 7 is a schematic diagram showing a third kind of connections of windings and center taps for the transformer device of FIGS. 3 and 4.

FIG. 7A is an equivalent circuit diagram of FIG. 7.

FIG. 8 is a schematic diagram showing a fourth kind of connections of windings and center taps for the transformer device of FIGS. 3 and 4.

FIG. 8A is an equivalent circuit diagram of FIG. 8.

FIG. 9 is a schematic diagram showing a first kind of connections of windings and center taps for a transformer device according to a second embodiment of the present invention.

FIG. 9A is an equivalent circuit diagram of FIG. 9.

FIG. 10 is a schematic diagram showing a second kind of connections of windings and center taps for a transformer device according to a second embodiment of the present invention.

FIG. 10A is an equivalent circuit diagram of FIG. 10.

FIG. 11 is a schematic diagram showing a third kind of connections of windings and center taps for a transformer device according to a second embodiment of the present invention.

FIG. 11A is an equivalent circuit diagram of FIG. 11.

FIG. 12 is a schematic diagram showing a fourth kind of connections of windings and center taps for a transformer device according to a second embodiment of the present invention.

FIG. 12A is an equivalent circuit diagram of FIG. 12.

FIG. 13 is a schematic diagram showing a first kind of connections of windings and center taps for a transformer device according to a third embodiment of the present invention.

FIG. 13A is an equivalent circuit diagram of FIG. 13.

FIG. 14 is a schematic diagram showing a second kind of connections of windings and center taps for a transformer device according to a third embodiment of the present invention.

FIG. 14A is an equivalent circuit diagram of FIG. 14.

FIG. 15 is a schematic diagram showing a third kind of connections of windings and center taps for a transformer device according to a third embodiment of the present invention.

FIG. 15A is an equivalent circuit diagram of FIG. 15.

FIG. 16 is a schematic diagram showing a fourth kind of connections of windings and center taps for a transformer device according to a third embodiment of the present invention.

FIG. 16A is an equivalent circuit diagram of FIG. 16.

FIG. 17 is a schematic diagram showing a first kind of connections of windings and center taps for a transformer device according to a fourth embodiment of the present invention.

FIG. 17A is an equivalent circuit diagram of FIG. 17.

FIG. 18 is a schematic diagram showing a second kind of connections of windings and center taps for a transformer device according to a fourth embodiment of the present invention.

FIG. 18A is an equivalent circuit diagram of FIG. 18.

FIG. 19 is a schematic diagram showing a third kind of connections of windings and center taps for a transformer device according to a fourth embodiment of the present invention.

FIG. 19A is an equivalent circuit diagram of FIG. 19.

FIG. 20 is a schematic diagram showing a fourth kind of connections of windings and center taps for a transformer device according to a fourth embodiment of the present invention.

FIG. 20A is an equivalent circuit diagram of FIG. 20.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

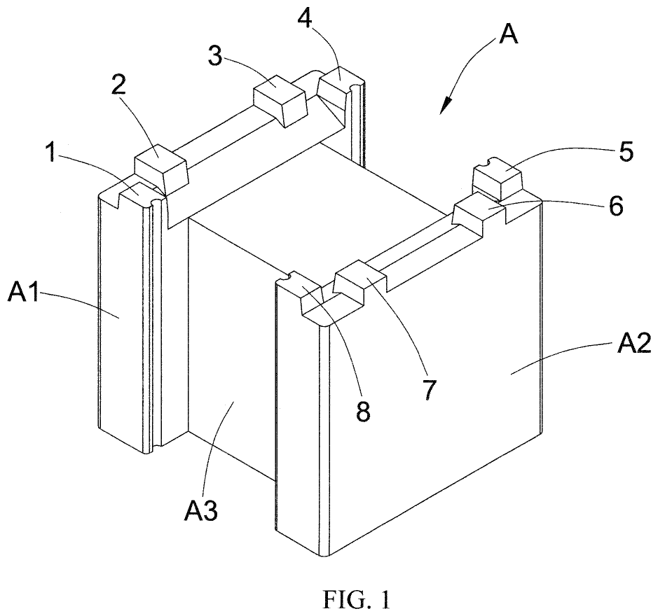

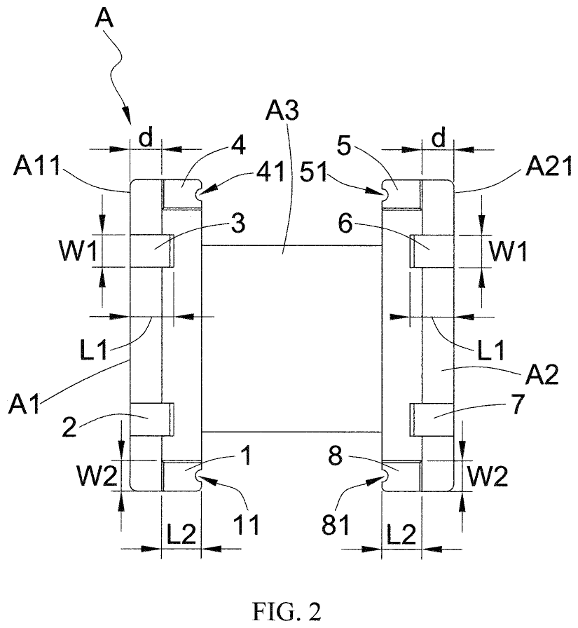

As shown in FIGS. 1 and 2, a magnetic core of a transformer device according to an embodiment of the present invention includes a magnetic core A having coil section A3, and a first flange A1 and a second flange A2 respectively at two opposite ends of the coil section A3.

The first flange A1 has a first electrode 1, a second electrode 2, a third electrode 3, and a fourth electrode 4 arranged on the first flange A1. The second electrode 2 and third electrode 3 (or, the inner electrodes) are positioned between the first electrode 1 and fourth electrode 4 (or, the outer electrodes). The outer electrodes 1 and 4 respectively have troughs 11 and 41 axially along inner siders of the outer electrodes 1 and 4. The inner electrodes 2 and 3 have a length L1 (along a direction towards the second flange A2) and a width W1 (along a direction parallel to the second flange A2). The outer electrodes 1 and 4 have a length L2 and a width W2. The length L1 is equal to the length L2. The width W1 is equal to the width W2. The outer electrodes 1 and 4 are positioned at a distance d relative to an outer side A11 of the first flange A1 and therefore closer to the coil section A3. The inner electrodes 2 and 3 are positioned flush against the outer side A11 and therefore farther away from the coil section A3. The troughs 11, 41 are for positioning wires. The distance d provides signal paths of equal length when outer electrodes are connected to inner electrodes.

The second flange A2 has a fifth electrode 5, a sixth electrode 6, a seventh electrode 7, and an eighth electrode 8 arranged on the second flange A2. The sixth electrode 6 and seventh electrode 7 (or, inner electrodes) are positioned between the fifth electrode 5 and eighth electrode 8 (or, outer electrodes). The outer electrodes 5 and 8 respectively have troughs 51 and 81 axially along inner sides of the outer electrodes 5 and 8. The inner electrodes 6 and 7 have a length L1 (along a direction towards the first flange A1) and a width W1 (along a direction parallel to the first flange A1). The outer electrodes 5 and 8 have a length L2 and a width W2. The length L1 is equal to the length L2. The width W1 is equal to the width W2. The outer electrodes 5 and 8 are positioned at a distance d relative to an outer side A21 of the second flange A2 and therefore closer to the coil section A3. The inner electrodes 6 and 7 are positioned flush against the outer side A21 and therefore farther away from the coil section A3. The troughs 51, 81 are for positioning wires. The distance d provides signal paths of equal length when outer electrodes are connected to inner electrodes.

The transformer device further includes a number of wire windings around the coil section A3. The windings are arranged into layers. Each winding has a first end and a second end. The first end is connected to an electrode on the first flange A1, and the second end is connected an electrode on the second flange A2.

The transformer device further includes two center taps 9, each having an end connected to an electrode on the first flange A1 and another end connected to an electrode on the second flange A2.

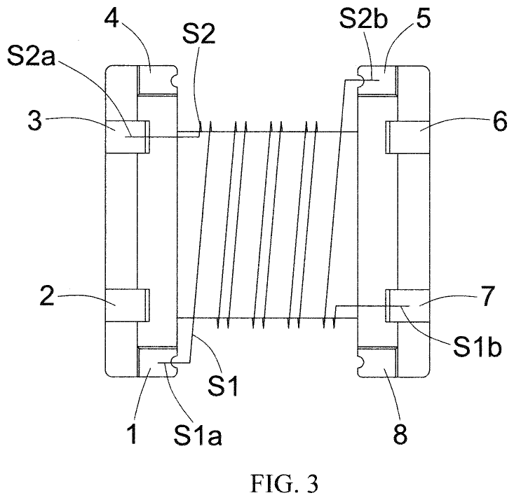

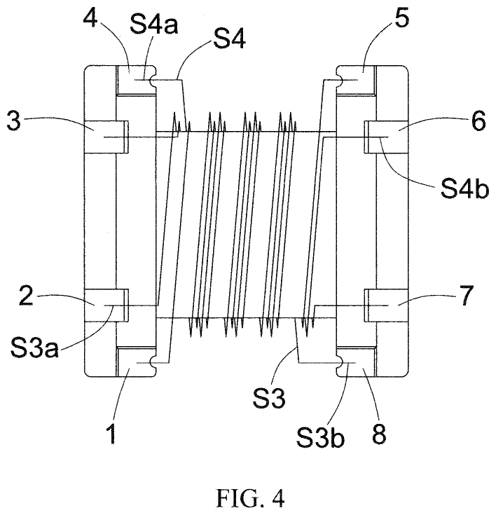

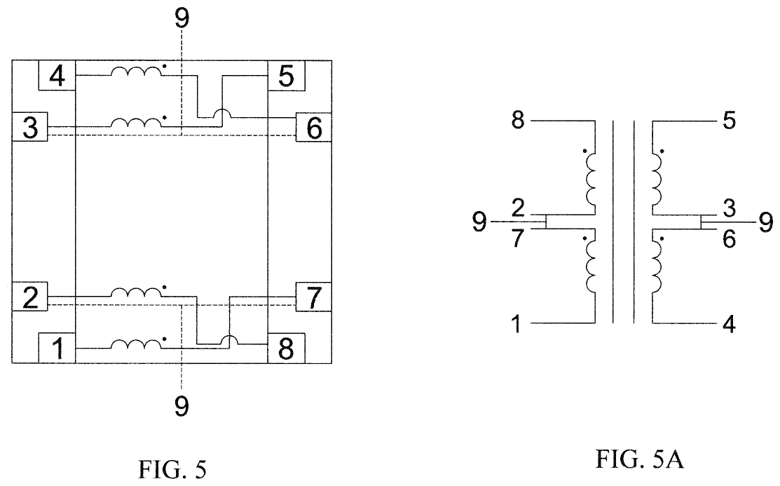

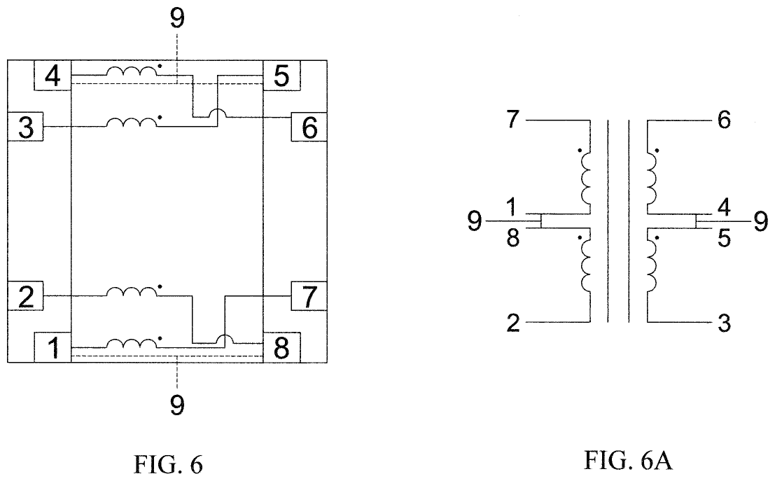

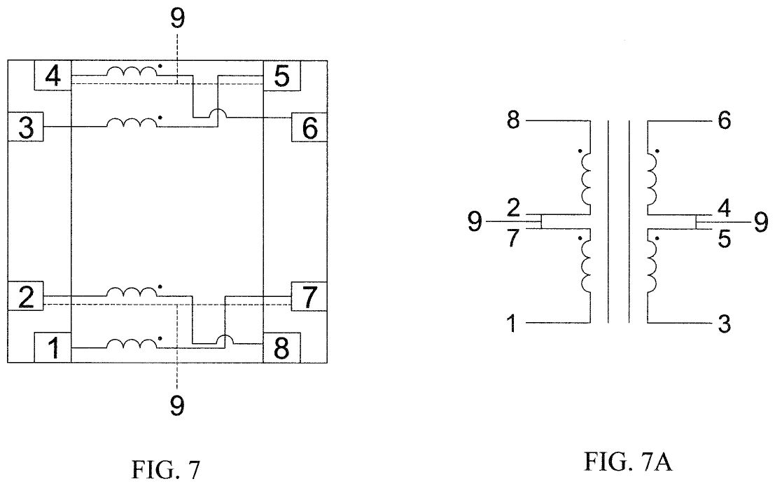

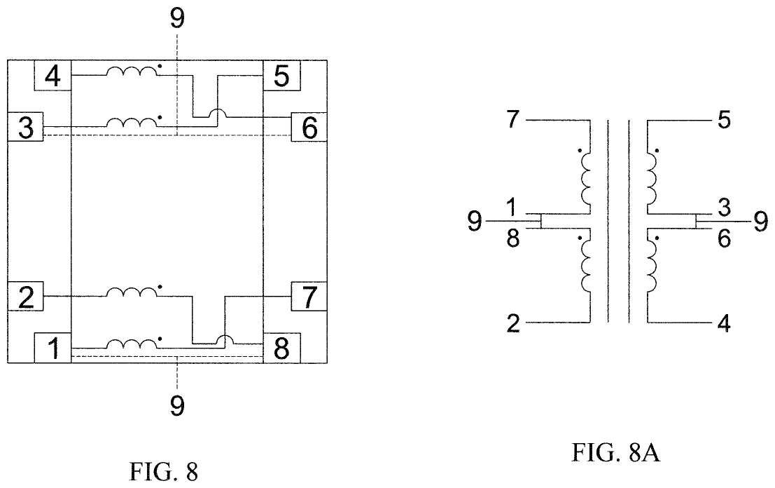

As shown in FIGS. 2 and 3, in a first embodiment of the present invention, a first winding S1 has its first end S1a connected to the first electrode 1 and a second winding S2 has its first end S2a connected to the third electrode 3. The first winding S1 and second winding S2 are wound clockwise around coil section A3, and then have their second ends S1b and S2b respectively connected to the seventh electrode 7 and fifth electrode 5. The first and second windings S1 and S2 form a first layer of windings. As shown in FIGS. 2 and 4, in the first embodiment of the present invention, a third winding S3 has its first end S3a connected to the second electrode 2 and the fourth winding S4 has its first end S4a connected to fourth electrode 4. The third winding S3 and fourth winding S4 are wound clockwise around the coil section A3, and then have their second ends S3b and S4b respectively connected to the eighth electrode 8 and sixth electrode 6. The third and fourth windings S3 and S4 form a second layer of windings. A center tap 9 is connected to the second electrode 2 and seventh electrode 7, and another center 9 is connected to the third electrode 3 and sixth electrode 6, as shown in FIGS. 5 and 5A. Alternatively, a center tap 9 is connected to the first electrode 1 and eighth electrode 8, and another center tap 9 is connected to the fourth electrode 4 and fifth electrode 5, as shown in FIGS. 6 and 6A. Alternatively, a center tap 9 is connected to the second electrode 2 and seventh electrode 7, and another center tap 9 is connected to the fourth electrode 4 and fifth electrode 5, as shown in FIGS. 7 and 7A. Alternatively, a center tap 9 is connected to the first electrode 1 and eighth electrode 8, and another center tap 9 is connected to the third electrode 3 and sixth electrode 6, as shown in FIGS. 8 and 8A. Through the above arrangement (winding directions, each winding connecting one outer electrode with an inner electrode, and center tap locations), signal paths along the windings are almost identical, thereby enhanced balance for impedance matching.

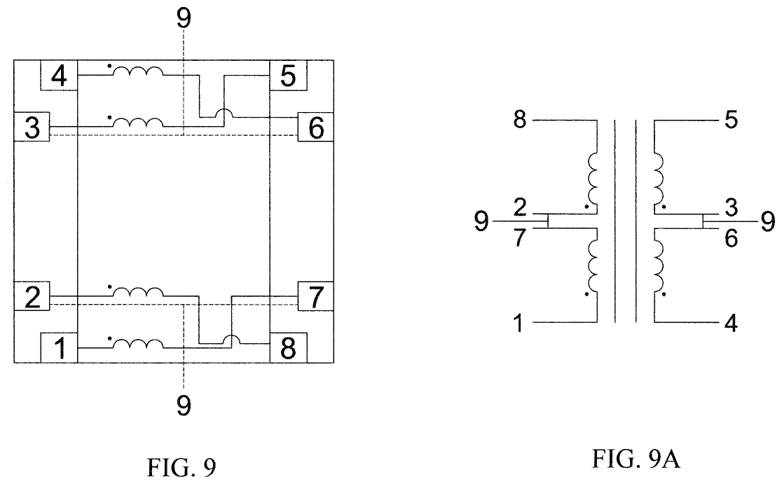

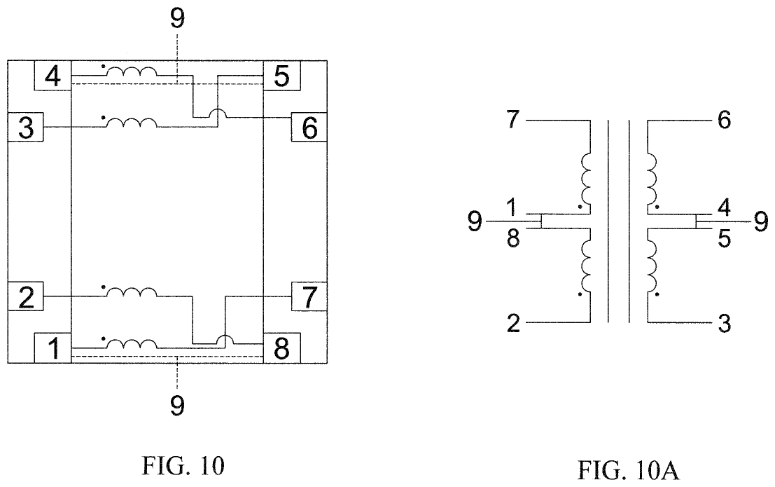

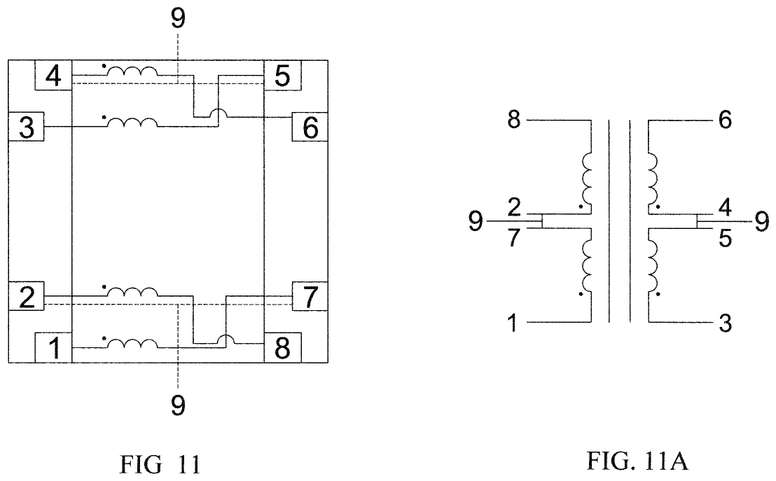

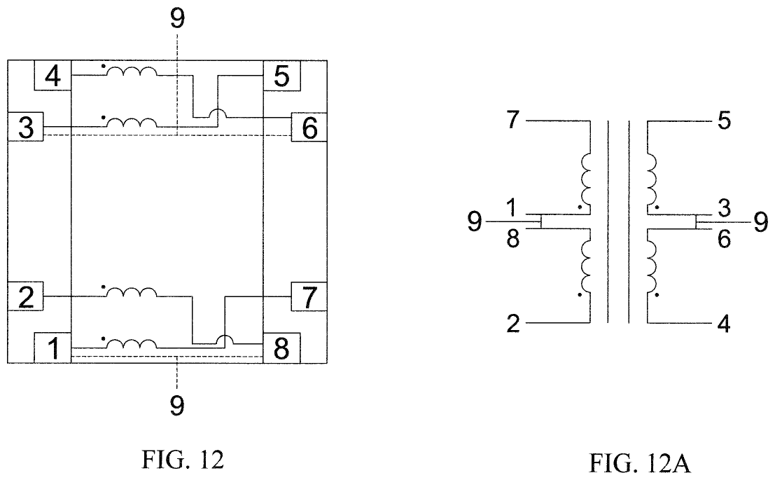

In a second embodiment of the present invention, the first winding S1 has its first end S1a connected to the first electrode 1 and the second winding S2 has its first end S2a connected to the third electrode 3. The first winding S1 and second winding S2 are wound counterclockwise around the coil section A3, and then have their second ends S1b and S2b respectively connected to the seventh electrode 7 and fifth electrode 5. The first and second windings S1 and S2 form the first layer of windings. The third winding S3 has its first end S3a connected to the second electrode 2 and the fourth winding S4 has its first end S4a connected to the fourth electrode 4. The third winding S3 and fourth winding S4 are wound counterclockwise around the coil section A3, and then have their second ends S3b and S4b respectively connected to the eighth electrode 8 and sixth electrode 6. The third and fourth windings S3 and S4 form the second layer of windings. A center tap 9 is connected to the second electrode 2 and seventh electrode 7, and another center 9 is connected to the third electrode 3 and sixth electrode 6, as shown in FIGS. 9 and 9A. Alternatively, a center tap 9 is connected to the first electrode 1 and eighth electrode 8, and another center tap 9 is connected to the fourth electrode 4 and fifth electrode 5, as shown in FIGS. 10 and 10A. Alternatively, a center tap 9 is connected to the second electrode 2 and seventh electrode 7, and another center tap 9 is connected to the fourth electrode 4 and fifth electrode 5, as shown in FIGS. 11 and 11A. Alternatively, a center tap 9 is connected to the first electrode 1 and eighth electrode 8, and another center tap 9 is connected to the third electrode 3 and sixth electrode 6, as shown in FIGS. 12 and 12A. Through the above arrangement (winding directions, each winding connecting one outer electrode with an inner electrode, and center tap locations), signal paths along the windings are almost identical, thereby enhanced balance for impedance matching.

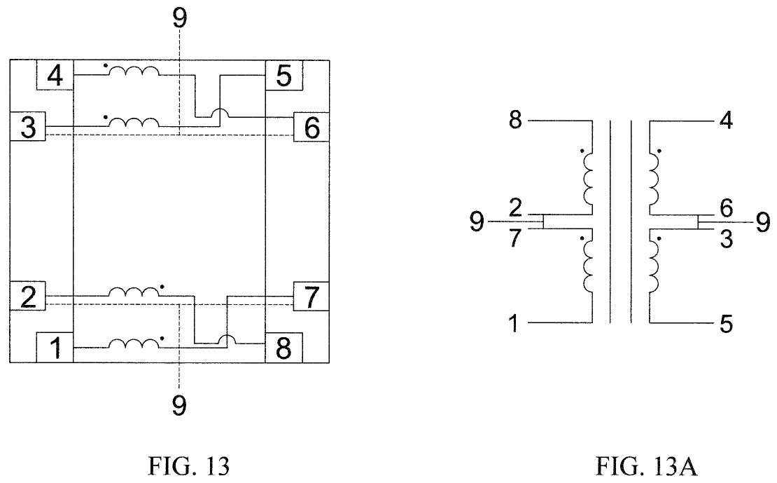

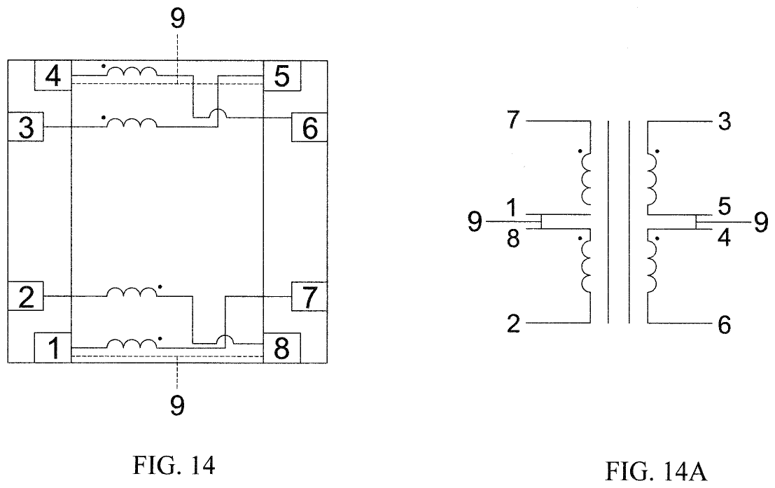

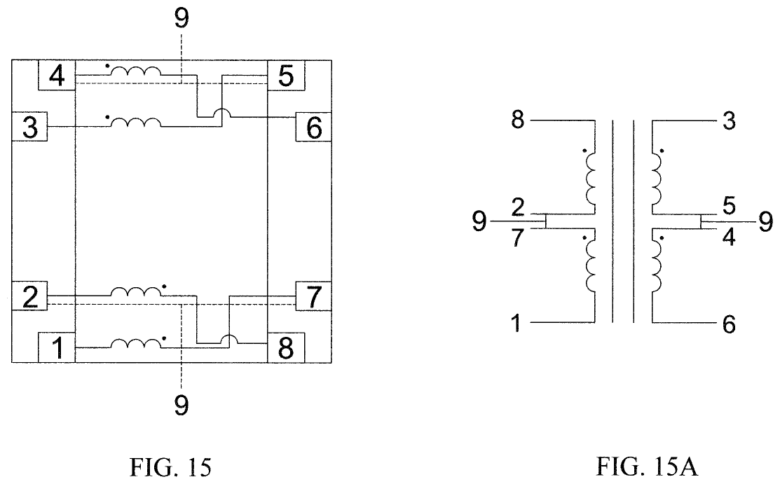

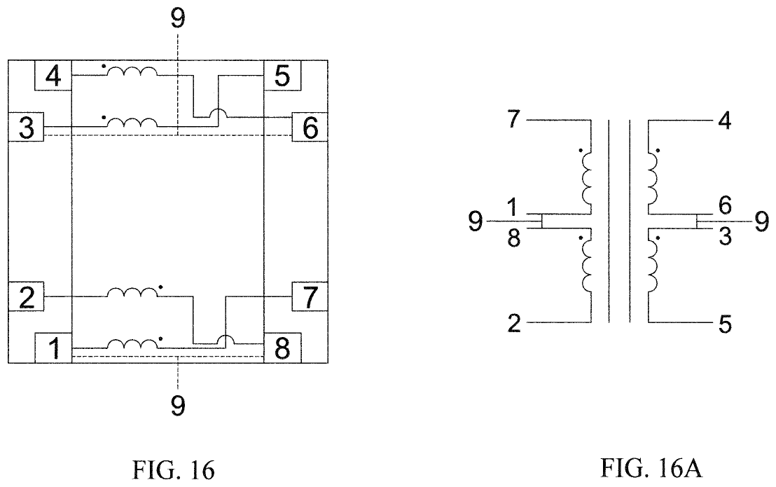

In a third embodiment of the present invention, the first winding S1 has its first end S1a connected to the first electrode 1 and the second winding S2 has its first end S2a connected to the second electrode 2. The first winding S1 and second winding S2 are wound clockwise around the coil section A3, and then have their second ends S1b and S2b respectively connected to the seventh electrode 7 and eighth electrode 8. The first and second windings S1 and S2 form the first layer of windings. The third winding S3 has its first end S3a connected to the third electrode 3 and the fourth winding S4 has its first end S4a connected to the fourth electrode 4. The third winding S3 and fourth winding S4 are wound counterclockwise around the coil section A3, and then have their second ends S3b and S4b respectively connected to the fifth electrode 5 and sixth electrode 6. The third and fourth windings S3 and S4 form the second layer of windings. A center tap 9 is connected to the second electrode 2 and seventh electrode 7, and another center 9 is connected to the third electrode 3 and sixth electrode 6, as shown in FIGS. 13 and 13A. Alternatively, a center tap 9 is connected to the first electrode 1 and eighth electrode 8, and another center tap 9 is connected to the fourth electrode 4 and fifth electrode 5, as shown in FIGS. 14 and 14A. Alternatively, a center tap 9 is connected to the second electrode 2 and seventh electrode 7, and another center tap 9 is connected to the fourth electrode 4 and fifth electrode 5, as shown in FIGS. 15 and 15A. Alternatively, a center tap 9 is connected to the first electrode 1 and eighth electrode 8, and another center tap 9 is connected to the third electrode 3 and sixth electrode 6, as shown in FIGS. 16 and 16A. Through the above arrangement (winding directions, each winding connecting one outer electrode with an inner electrode, and center tap locations), signal paths along the windings are almost identical, thereby enhanced balance for impedance matching.

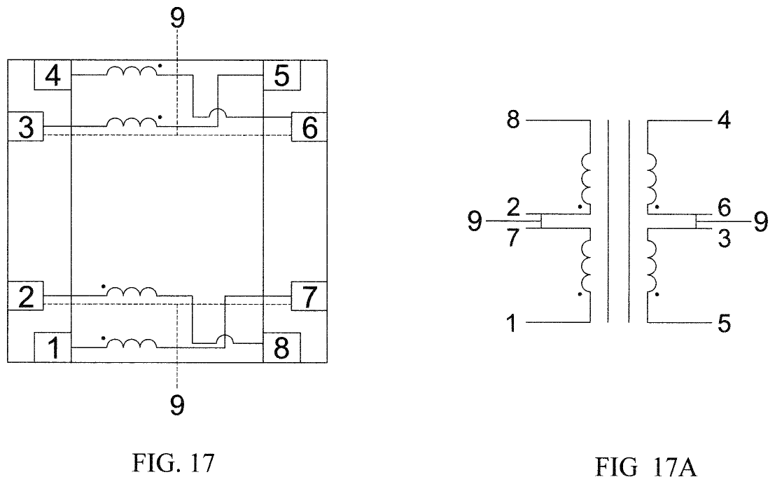

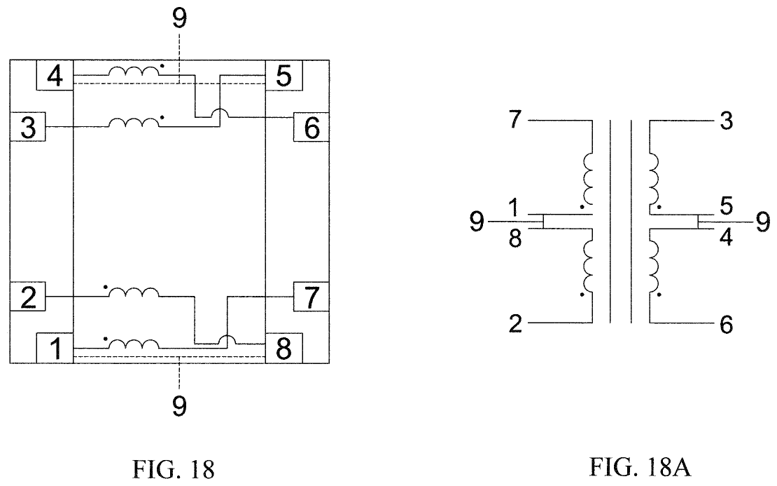

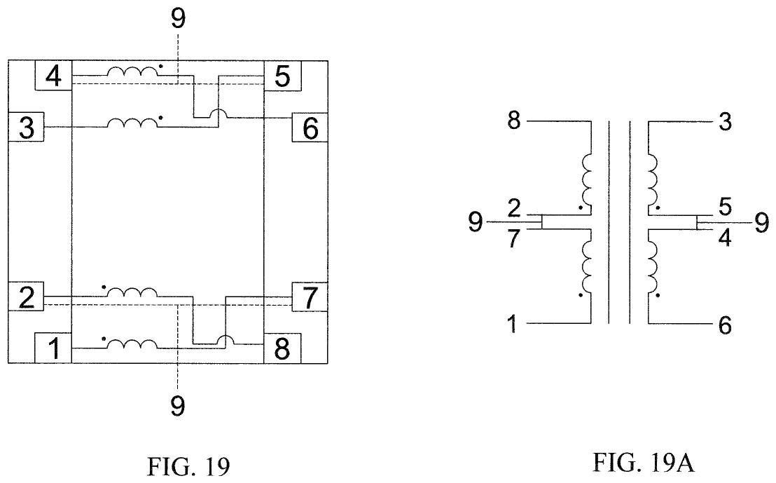

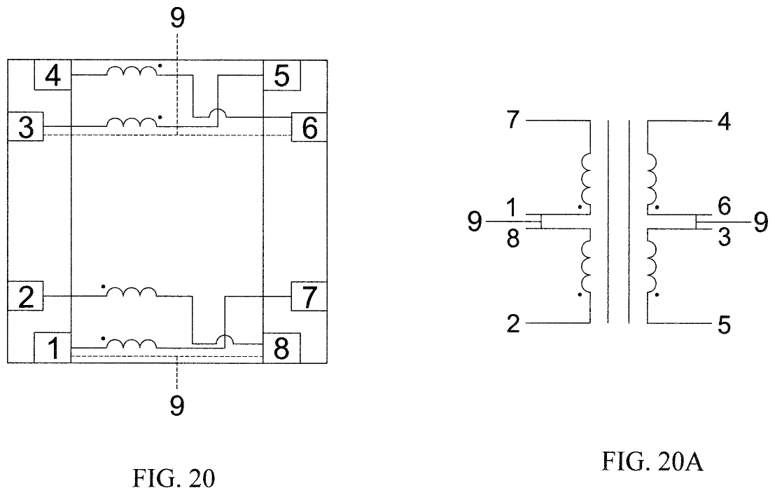

In a fourth embodiment of the present invention, the first winding S1 has its first end S1a connected to the first electrode 1 and the second winding S2 has its first end S2a connected to the second electrode 2. The first winding S1 and second winding S2 are wound counterclockwise around the coil section A3, and then have their second ends S1b and S2b respectively connected to the seventh electrode 7 and eighth electrode 8. The first and second windings S1 and S2 form the first layer of windings. The third winding S3 has its first end S3a connected to the third electrode 3 and the fourth winding S4 has its first end S4a connected to the fourth electrode 4. The third winding S3 and fourth winding S4 are wound clockwise around the coil section A3, and then have their second ends S3b and S4b respectively connected to the fifth electrode 5 and sixth electrode 6. The third and fourth windings S3 and S4 form the second layer of windings. A center tap 9 is connected to the second electrode 2 and seventh electrode 7, and another center 9 is connected to the third electrode 3 and sixth electrode 6, as shown in FIGS. 17 and 17A. Alternatively, a center tap 9 is connected to the first electrode 1 and eighth electrode 8, and another center tap 9 is connected to the fourth electrode 4 and fifth electrode 5, as shown in FIGS. 18 and 18A. Alternatively, a center tap 9 is connected to the second electrode 2 and seventh electrode 7, and another center tap 9 is connected to the fourth electrode 4 and fifth electrode 5, as shown in FIGS. 19 and 19A. Alternatively, a center tap 9 is connected to the first electrode 1 and eighth electrode 8, and another center tap 9 is connected to the third electrode 3 and sixth electrode 6, as shown in FIGS. 20 and 20A. Through the above arrangement (winding directions, each winding connecting one outer electrode with an inner electrode, and center tap locations), signal paths along the windings are almost identical, thereby enhancing the balance of impedance matching.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A transformer device, comprising:
a magnetic core having a coil section;
a first flange at a first end of the coil section having outer electrodes including a first electrode and a fourth electrode and inner electrodes including a second electrode and a third electrode, where the inner electrodes are positioned between the outer electrodes, and the outer electrodes are positioned at a distance relative to an outer side of the first flange and therefore closer to the coil section than the inner electrodes;
a second flange at a second end of the coil section opposite to the first end having outer electrodes including a fifth electrode and an eighth electrode and inner electrodes including a sixth electrode and a seventh electrode, where the inner electrodes are positioned between the outer electrodes, and the outer electrodes are positioned at a distance relative to an outer side of the second flange and therefore closer to the coil section than the inner electrodes;
a plurality of windings around the coil section arranged into a first layer of winding and a second layer of winding, where each winding has a first end and a second end, the first end is connected to an electrode on the first flange, and the second end is connected an electrode on the second flange; and
two center taps, each having an end connected to an electrode on the first flange and another end connected to an electrode on the second flange;
wherein the outer electrodes on the first flange have equal length and width to those of the inner electrodes on the first flange; and the outer electrodes on the second flange have equal length and width to those of the inner electrodes on the second flange.

2. The transformer device according to claim 1, wherein each outer electrode has a trough axially along an inner sider of the outer electrode.

3. The transformer device according to claim 1, wherein the first layer of windings comprises a first winding and a second winding; the first and second windings are wound clockwise around the coil section, have their first ends respectively connected to the first and third electrodes, and have their second ends respectively connected to the seventh and fifth electrodes; the second layer of windings comprises a third winding and a fourth winding; and the third and fourth windings are wound clockwise around the coil section, have their first ends respectively connected to the second and fourth electrodes, and have their second ends respectively connected to the eighth and sixth electrodes.

4. The transformer device according to claim 1, wherein the first layer of windings comprises a first winding and a second winding; the first and second windings are wound counterclockwise around the coil section, have their first ends respectively connected to the first and third electrodes, and have their second ends respectively connected to the seventh and fifth electrodes; the second layer of windings comprises a third winding and a fourth winding; and the third and fourth windings are wound counterclockwise around the coil section, have their first ends respectively connected to the second and fourth electrodes, and have their second ends respectively connected to the eighth and sixth electrodes.

5. The transformer device according to claim 1, wherein the first layer of windings comprises a first winding and a second winding; the first and second windings are wound clockwise around the coil section, have their first ends respectively connected to the first and second electrodes, and have their second ends respectively connected to the seventh and eighth electrodes; the second layer of windings comprises a third winding and a fourth winding; and the third and fourth windings are wound counterclockwise around the coil section, have their first ends respectively connected to the third and fourth electrodes, and have their second ends respectively connected to the fifth and sixth electrodes.

6. The transformer device according to claim 1, wherein the first layer of windings comprises a first winding and a second winding; the first and second windings are wound counterclockwise around the coil section, have their first ends respectively connected to the first and second electrodes, and have their second ends respectively connected to the seventh and eighth electrodes; the second layer of windings comprises a third winding and a fourth winding; and the third and fourth windings are wound clockwise around the coil section, have their first ends respectively connected to the third and fourth electrodes, and have their second ends respectively connected to the fifth and sixth electrodes.

7. The transformer device according to claim 3, wherein a center tap is connected to the second and seventh electrodes; and another center is connected to the third and sixth electrodes.

8. The transformer device according to claim 3, wherein a center tap is connected to the first and eighth electrodes; and another center tap is connected to the fourth and fifth electrodes.

9. The transformer device according to claim 3, wherein a center tap is connected to the second and seventh electrodes; and another center tap is connected to the fourth and fifth electrodes.

10. The transformer device according to claim 3, wherein a center tap is connected to the first and eighth electrodes; and another center tap is connected to the third and sixth electrodes.

11. The transformer device according to claim 4, wherein a center tap is connected to the second and seventh electrodes; and another center is connected to the third and sixth electrodes.

12. The transformer device according to claim 4, wherein a center tap is connected to the first and eighth electrodes; and another center tap is connected to the fourth and fifth electrodes.

13. The transformer device according to claim 4, wherein a center tap is connected to the second and seventh electrodes; and another center tap is connected to the fourth and fifth electrodes.

14. The transformer device according to claim 4, wherein a center tap is connected to the first and eighth electrodes; and another center tap is connected to the third and sixth electrodes.

15. The transformer device according to claim 5, wherein a center tap is connected to the second and seventh electrodes; and another center is connected to the third and sixth electrodes.

16. The transformer device according to claim 5, wherein a center tap is connected to the first and eighth electrodes; and another center tap is connected to the fourth and fifth electrodes.

17. The transformer device according to claim 5, wherein a center tap is connected to the second and seventh electrodes; and another center tap is connected to the fourth and fifth electrodes.

18. The transformer device according to claim 5, wherein a center tap is connected to the first and eighth electrodes; and another center tap is connected to the third and sixth electrodes.

19. The transformer device according to claim 6, wherein a center tap is connected to the second and seventh electrodes; and another center is connected to the third and sixth electrodes.

20. The transformer device according to claim 6, wherein a center tap is connected to the first and eighth electrodes; and another center tap is connected to the fourth and fifth electrodes.

21. The transformer device according to claim 6, wherein a center tap is connected to the second and seventh electrodes; and another center tap is connected to the fourth and fifth electrodes.

22. The transformer device according to claim 6, wherein a center tap is connected to the first and eighth electrodes; and another center tap is connected to the third and sixth electrodes.
